(19) United States
(12) Patent Application Publication
(10) Pub. No.: US 2025/0310496 A1
(43) Pub. Date: Oct. 2, 2025

(54) DETERMINATION METHOD OF AREA FOR DISPLAYING CONTENT

(71) Applicant: SEIKO EPSON CORPORATION, Tokyo (JP)

(72) Inventor: Taku NAKAMURA, Ina-shi (JP)

(73) Assignee: SEIKO EPSON CORPORATION, Tokyo (JP)

(21) Appl. No.: 19/090,495

(22) Filed: Mar. 26, 2025

(30) Foreign Application Priority Data
Mar. 27, 2024 (JP) 2024-051310

(51) Int. Cl. H04N 9/31; G06T 3/08; G06T 7/11; G06T 7/215; G06T 7/521; G06T 7/90

(52) U.S. Cl. CPC H04N 9/3185; G06T 3/08; G06T 7/11; G06T 7/215; G06T 7/521; G06T 7/90; H04N 9/3182; G06T 2207/10024; G06T 2207/20021

(57) ABSTRACT

A determination device acquires, from an imaging device, a captured image including a projection area in which a projection object serving as a display destination of content including a plurality of images is disposed, and acquires first external information on a feature of distance in the projection area from an external sensor. The determination device uses an image recognition server and a segmentation server to acquire, based on the acquired captured image and first external information, area information for dividing the captured image into a plurality of areas and grouping the plurality of areas. The determination device determines, for each group, an image to be displayed in each of the plurality of areas among the plurality of images constituting the content based on the area information.

The present application is based on, and claims priority from JP Application Serial Number 2024-051310, filed Mar. 27, 2024, the disclosure of which is hereby incorporated by reference herein in its entirety.

### BACKGROUND

### 1. Technical Field

The present disclosure relates to a determination method of an area for displaying content.

### 2. Related Art

JP-A-2015-184383 discloses measuring a distance between an object in a projection area and a projector and displaying a projection image on a target portion.

However, when there are a plurality of target portions and a distance between each target portion and the projector is different, it is necessary to set an image to be projected for each of the plurality of target portions, and a load on a user related to content production is large. For example, when a plurality of visual structures such as depressions and colors are present in one object desired to be a projection destination of content, in projection mapping implemented by displaying each of a plurality of images constituting the content in a plurality of target areas selected from a plurality of depressed surfaces or a plurality of protruding surfaces, the number of target areas for which the user sets an image is large, and thus the load on the user related to content production is large. Further, for example, in projection mapping implemented by setting a plurality of images constituting the content one by one for a plurality of objects, similarly, the load on the user related to content production is large.

### SUMMARY

A determination method of an area for displaying content according to an aspect of the present disclosure includes: acquiring a captured image including a projection area in which a projection object serving as a display destination of content including a plurality of images is disposed; acquiring area information for dividing the captured image into a plurality of areas and grouping the plurality of areas, based on the captured image and first external information on a feature of distance or color in the projection area; and determining, for each of the plurality of areas, an image to be displayed in the area among the plurality of images for each group based on the area information.

### BRIEF DESCRIPTION OF THE DRAWINGS

FIG. 1 is a diagram illustrating a configuration example of a system 1 including a determination device 10 that executes a determination method according to an embodiment of the present disclosure.

FIG. 2 is a diagram illustrating an example of a projection object in the embodiment.

FIG. 3 is a diagram illustrating an example of area division by a segmentation server 50.

FIG. 4 is a diagram illustrating a configuration example of a determination device 10.

FIG. 5 is a diagram illustrating an example of area division by the determination device 10.

FIG. 6 is a flowchart illustrating a flow of processing in a determination method executed by a processing device 110 of the determination device 10 according to a program PRA.

### DESCRIPTION OF EMBODIMENTS

Various technically preferable limitations are imposed on the following embodiments. However, embodiments of the present disclosure are not limited to the embodiments described below.

### 1. Embodiment

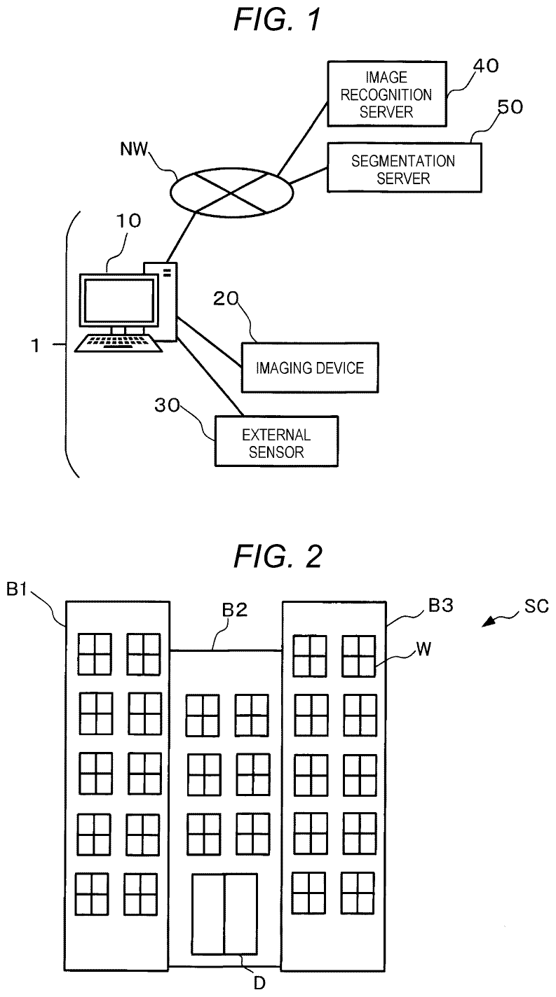

FIG. 1 is a diagram illustrating a configuration example of a system 1 according to an embodiment of the present disclosure. The system 1 is a system for supporting implementation of projection mapping. The projection mapping in the embodiment is implemented by projecting a plurality of images constituting content onto a projection object from a projector, which is not shown in detail in FIG. 1. FIG. 2 is a diagram illustrating an example of a projection object in the embodiment. The projection object in the embodiment is a building SC having a portion B1 and a portion B3 protruding forward and a portion B2 recessed on a depth side. Windows W are provided in each of the portion B1 and the portion B3, and windows W and a door D for entering and exiting the building SC are provided in the portion B2. In FIG. 2, in order to avoid complication of the drawing, only one window provided in the portion B3 is denoted by a reference sign.

The system 1 is a system for easily setting images constituting content in each of a plurality of target areas (for example, the portion B1 and the portion B3) in a projection area where a projection object is disposed. As illustrated in FIG. 1, the system 1 includes a determination device 10, an imaging device 20, and an external sensor 30. Each of the imaging device 20 and the external sensor 30 is connected to the determination device 10 in a wireless or wired manner. The determination device 10 communicates with an image recognition server 40 and a segmentation server 50 via a network NW such as the Internet.

The imaging device 20 is, for example, a camera, and is disposed at a position and in a posture such that the entire projection area falls within an imaging range. That is, in the embodiment, the imaging device 20 captures an image including the entire projection area. The imaging device 20 supplies captured image data representing the captured image to the determination device 10.

The external sensor 30 acquires external information (hereinafter referred to as first external information) on a feature of a distance in the projection area (a distance from the external sensor 30 to the projection object) or a feature of a color in the projection area (a color of the projection object), and supplies the acquired first external information to the determination device 10. The external sensor 30 in the embodiment is a depth sensor, and the first external information is information representing a feature related to a distance in the projection area. Specifically, the first external information in the embodiment is depth information. A specific example of the first external information on a feature of a color in the projection area is RGBA information representing a color and transparency. In a case where the information on a feature of a color in the projection area is used as the first external information, it is sufficient to cause the imaging device 20 to also serve as the external sensor 30 and to acquire the first external information from a captured image captured by the imaging device 20.

The image recognition server 40 is a device that, when an object is reflected in an image represented by image data received via the network NW, recognizes a type of the object by analyzing the image and returns result information indicating a recognition result. The result information includes information indicating the type of the object and a range occupied by an image of the object in the image. The result information in the embodiment includes, for a portion having a unique name among portions of the object (specific examples of the portion in a case where the object is a building include a window, a decorative window, a cornice, a box-like ridge, an echinus, an architrave, a placing joint, and a door. In addition, patterns such as an arrowhead pattern, a checkered pattern, and a Shippo pattern applied to the object are also included in the portion having a unique name among the portions of the object), information indicating the name of the portion and a range occupied by the portion in the image. When a plurality of objects are reflected in the image represented by the image data received via the network NW, the image recognition server 40 returns result information for each of the plurality of objects. An existing image recognition technique may be appropriately adopted for the image recognition server 40.

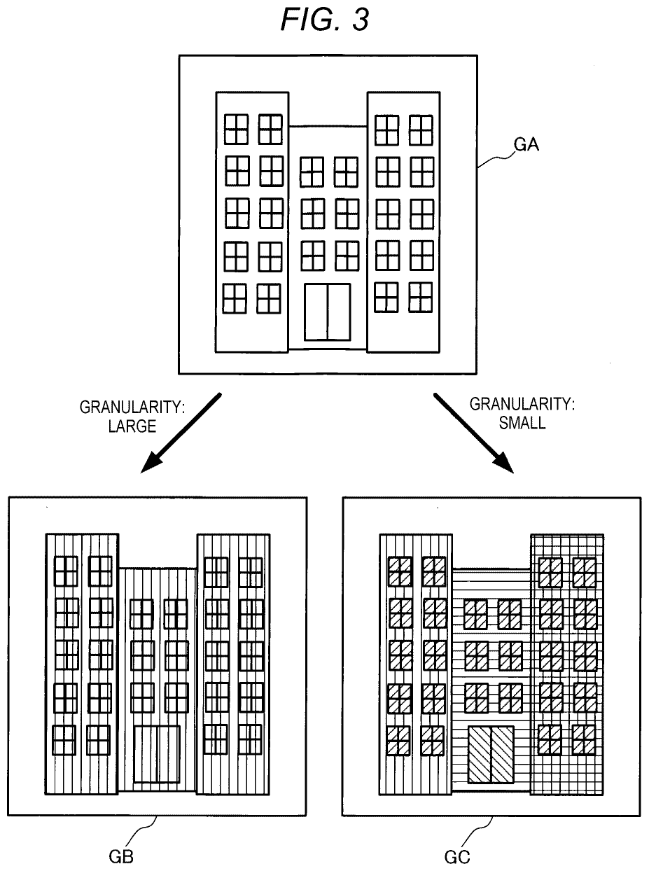

The segmentation server 50 is a device that executes segmentation. The segmentation is a technique of dividing an image into a plurality of areas. The segmentation server 50 divides an image, which is represented by image data received via the network NW, into a plurality of areas based on division granularity designated by the determination device 10, and returns a division result to the determination device 10. The division granularity is information for designating fineness of area division. FIG. 3 is a diagram for illustrating an example of area division by the segmentation server 50. In FIG. 3, in each area divided by the segmentation server 50, areas are hatched. When image data representing an image GA of the building SC is input to the segmentation server 50 and the division granularity is designated as “large”, as illustrated in an image GB in FIG. 3, area division is performed with the entire building SC as one area. On the other hand, when the image data representing the image GA is input to the segmentation server 50 and the division granularity is designated as “small”, as illustrated in an image GC in FIG. 3, each of the portion B1, the portion B2, and the portion B3 is divided as one area, and each of the window W and the door D is divided as a separate area. In FIG. 3, in order to avoid complication of the drawing, the same hatching is applied to all the windows W, but actually, the windows W are divided as separate areas. Similarly to the image recognition server 40, an existing technique may be appropriately adopted for the segmentation server 50.

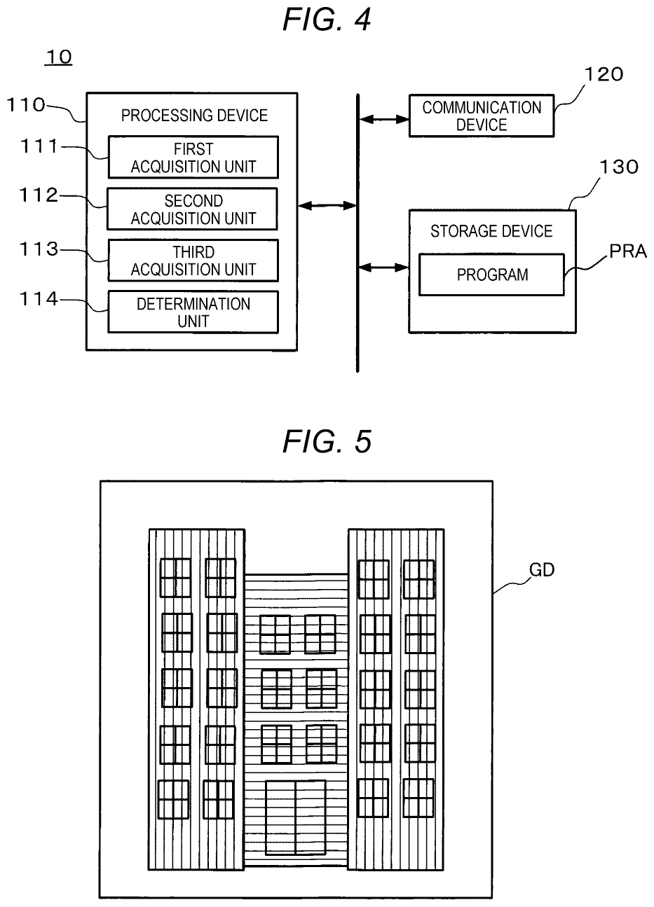

The determination device 10 is, for example, a personal computer, a smartphone, or a tablet terminal. FIG. 4 is a diagram illustrating a configuration example of the determination device 10. As illustrated in FIG. 4, the determination device 10 includes a processing device 110, a communication device 120, and a storage device 130. Although not illustrated in detail in FIG. 4, the determination device 10 includes a display device displaying various images and an input device for receiving a user operation.

The processing device 110 is one or more processors. The processing device 110 is, for example, a central processing unit (CPU). The processing device 110 operates according to a program PRA stored in the storage device 130 and functions as a control center of the determination device 10. The communication device 120 is a device that performs wireless communication or wired communication with other devices and includes, for example, an interface circuit. Specific examples of other devices that communicate with the communication device 120 include the imaging device 20, the external sensor 30, the image recognition server 40, and the segmentation server 50.

The storage device 130 is a recording medium readable by the processing device 110. The storage device 130 includes, for example, a nonvolatile memory and a volatile memory. The nonvolatile memory is, for example, a read only memory (ROM), an erasable programmable read only memory (EPROM), or an electrically erasable programmable read only memory (EEPROM). The volatile memory is, for example, a random access memory (RAM).

Examples of various programs stored in the nonvolatile memory include a kernel program and the program PRA. In FIG. 4, illustration of the kernel program is omitted. The kernel program is a program for causing the processing device 110 to implement an operating system (OS). When the determination device 10 is powered on, the processing device 110 reads the kernel program from the nonvolatile memory to the volatile memory and starts executing the read kernel program. When being instructed, via an input device (not illustrated), to start executing another program, the processing device 110 that operates according to the kernel program starts executing the other program. For example, when being instructed to start executing the program PRA, the processing device 110 reads the program PRA from the nonvolatile memory to the volatile memory and starts executing the program PRA read to the volatile memory.

The processing device 110 operating according to the program PRA functions as a first acquisition unit 111, a second acquisition unit 112, a third acquisition unit 113, and a determination unit 114 illustrated in FIG. 4. That is, each of the first acquisition unit 111, the second acquisition unit 112, the third acquisition unit 113, and the determination unit 114 illustrated in FIG. 4 is a software module implemented by causing the processing device 110 to operate according to the program PRA. Roles of the first acquisition unit 111, the second acquisition unit 112, the third acquisition unit 113, and the determination unit 114 illustrated in FIG. 4 are as follows.

The first acquisition unit 111 acquires captured image data representing a captured image including a projection area by controlling the imaging device 20. The second acquisition unit 112 acquires the first external information by communicating external with the sensor 30. By communicating with an external storage device that acquires and stores the first external information from the external sensor 30 in advance, the second acquisition unit 112 may acquire the first external information stored in the external storage device.

Based on the captured image data acquired by the first acquisition unit 111 and the first external information acquired by the second acquisition unit 112, the third acquisition unit 113 acquires area information for dividing the captured image represented by the captured image data into a plurality of areas and grouping the plurality of areas.

More specifically, the third acquisition unit 113 first transmits the captured image data acquired by the first acquisition unit 111 to the image recognition server 40 by using the communication device 120. The third acquisition unit 113 receives result information, which is transmitted from the image recognition server 40 via the network NW, by using the communication device 120, thereby acquiring the result information representing a recognition result regarding a projection object reflected in the captured image represented by the captured image data.

Next, the third acquisition unit 113 transmits the captured image data acquired by the first acquisition unit 111 to the segmentation server 50 by using the communication device 120, and divides an image in a range corresponding to the projection object in the image represented by the captured image data into a plurality of areas. In the embodiment, the third acquisition unit 113 designates “small” as the division granularity, and may designate the division granularity according to the type of the projection object indicated by the result information. For example, if the type of the projection object is an object that can be decomposed into a plurality of portions, such as a building, “small” may be designated as the division granularity, and if the type of the projection object is an object that cannot be decomposed into a plurality of portions, such as a projection screen, “large” may be designated as the division granularity. The third acquisition unit 113 may divide an image in a range in which the feature of distance indicated in the first external information is the same or an image in a range in which a distance difference is less than a predetermined threshold into a plurality of areas. The third acquisition unit 113 groups two or more divided areas into one group, and generates area information representing areas belonging to the group for each group. The area information corresponding to a certain group includes information indicating a range occupied by each area belonging to the group in the captured image.

For example, it is assumed that the captured image to be subjected to the area division is the image GA in FIG. 3, the segmentation server 50 is caused to perform the area division by designating “small” as the division granularity, and the area division is performed as illustrated in the image GC in FIG. 3. In this case, since the feature of distance is different between the portions B1 and B3 and the portion B2 and the feature of distance is the same or the distance difference is less than the predetermined threshold in the portions B1 and B3, the third acquisition unit 113 groups areas corresponding to the portions B1 and B2 into a first group and groups an area corresponding to the portion B2 into a second group as illustrated in an image GD in FIG. 5.

As described above, in the segmentation, an image can be finely divided by designating the division granularity to be small, but division expected by a user is not always performed, and grouping of divided areas cannot be performed. For example, even if the user desires to implement projection mapping by projecting an image only on the portion B1 and the portion B3 of the building SC, that is, to perform the area division of setting the portion B1 and the portion B3 into one group, the user's expectation cannot be met only by segmentation. In the embodiment, grouping of the areas divided by segmentation is implemented by conditioning with the first external information. When a content producer performs area division in the projection mapping, it is common to perform the area division basically based on information that can be perceived by a person, such as a geometric shape or a color of a projection object, and thus a result of area grouping by conditioning with the first external information conforms to the usual sense of the content producer.

The third acquisition unit 113 in the embodiment groups, based on the first external information, the plurality of areas that are obtained by dividing the image including the projection area by segmentation, and may perform grouping in consideration of names of the portions included in the result information so that portions of the same type among the portions of the projection object are grouped into the same group. When a plurality of projection objects are reflected in the captured image represented by the captured image data, the third acquisition unit 113 may identify each of the plurality of projection objects and perform grouping in consideration of an identification result. Specifically, the third acquisition unit 113 may identify types of the plurality of projection objects and perform grouping in consideration of the types of the objects included in the result information so that the projection objects of the same type belong to the same group.

For each of the plurality of areas grouped by the third acquisition unit 113, the determination unit 114 determines an image to be displayed in the area among a plurality of images constituting the content for each group based on the area information, and generates data (hereinafter referred to as a mask map) indicating allocation of the images constituting the content to the projection area. In the embodiment, the determination unit 114 displays an image representing the generated mask map on a display device (not illustrated in FIG. 4). The user visually checks the mask map displayed on the display device, and operates the input device (not illustrated in FIG. 4) to instruct designation, addition, deletion, change, or the like of an area to which an image constituting the content is to be allocated. The determination unit 114 updates the mask map according to the operation, thereby completing the mask map. For example, when the user desires to implement the projection mapping by projecting images only on the portion B1 and the portion B3 of the building SC, a mask map for implementing the projection mapping is completed only by designating the first group, which is indicated by the area information, as a display destination of images constituting the content.

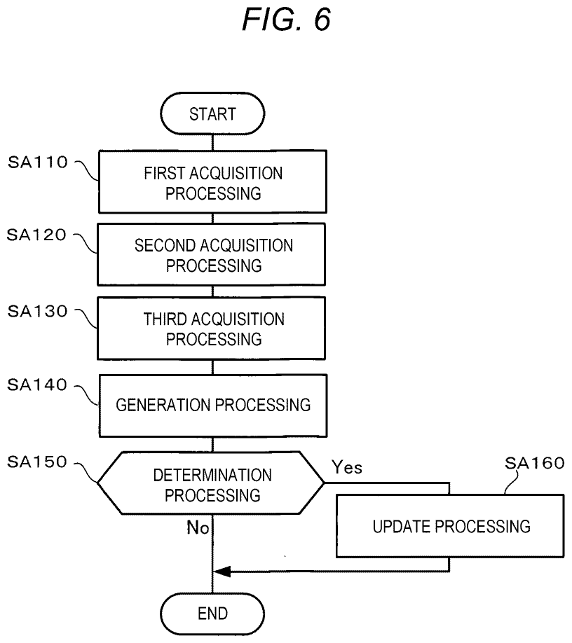

The processing device 110 operating according to the program PRA executes a determination method markedly indicating characteristics of the present disclosure. FIG. 6 is a flowchart illustrating a flow of processing in the determination method. As illustrated in FIG. 6, the determination method includes first acquisition processing SA110, second acquisition processing SA120, third acquisition processing SA130, generation processing SA140, determination processing SA150, and update processing SA160.

In the first acquisition processing SA110, the processing device 110 functions as the first acquisition unit 111. In the first acquisition processing SA110, the processing device 110 acquires captured image data representing a captured image of the entire projection area by controlling the imaging device 20.

In the second acquisition processing SA120 following the first acquisition processing SA110, the processing device 110 functions as the second acquisition unit 112. In the second acquisition processing SA120, the processing device 110 acquires first external information on a feature of distance in a projection area by controlling the external sensor 30. Although the second acquisition processing SA120 is executed following the first acquisition processing SA110 in the embodiment, the second acquisition processing SA120 may be executed prior to the first acquisition processing SA110.

In the third acquisition processing SA130, the processing device 110 functions as the third acquisition unit 113. In the third acquisition processing SA130, based on the captured image data acquired in the first acquisition processing SA110 and the first external information acquired in the second acquisition processing SA120, the processing device 110 acquires area information for dividing the captured image represented by the captured image data into a plurality of areas and grouping the plurality of areas.

In the generation processing SA140, the determination processing SA150, and the update processing SA160, the processing device 110 functions as the determination unit 114. In the generation processing SA140, the processing device 110 generates a mask map for allocating images constituting content to the projection area based on the area information, and displays an image representing the mask map on the display device. As described above, the user can visually check the mask map displayed on the display device and operate the input device to instruct designation, addition, deletion, change, or the like of an area to which an image constituting the content is to be allocated. In the determination processing SA150, the processing device 110 determines whether addition, deletion, change, or the like of an area to which an image constituting the content is to be allocated is instructed. When the processing device 110 receives, from the input device, data representing an operation of instructing designation, addition, deletion, change, or the like of an area to which an image constituting the content is to be allocated, a determination result of the determination processing SA150 is “Yes”. Conversely, when the processing device 110 does not receive, from the input device, data representing an operation of instructing designation, addition, deletion, change, or the like of an area to which an image constituting the content is to be assigned, the determination result of the determination processing SA150 is “No”. If the determination result of the determination processing SA150 is “No”, the processing device 110 ends the execution of the determination method. If the determination result of the determination processing SA150 is “Yes”, the processing device 110 ends the execution of the determination method after executing the update processing SA160 of updating a mask map according to the operation of the user.

As described above, according to the embodiment, a certain degree of mask map is automatically generated by grouping areas divided by segmentation conditioned with the first external information. A mask map suitable for the projection object can be generated by the user appropriately correcting the mask map automatically generated by the determination device 10. According to the embodiment, the load on the user is reduced and the load on the user related to content production is reduced as compared with a mode in which the user manually creates a mask map from scratch.

### 2. Other Embodiments

A mask map of a plurality of patterns can be obtained by changing a condition regarding a feature of distance or color indicated by first external information, a condition regarding division granularity, or a condition regarding a portion of an object. A plurality of mask maps created by appropriately changing these conditions may be presented to a user to allow the user to select a desired mask map. A plurality of mask maps may be generated in advance by appropriately changing the condition regarding a feature of distance or color indicated by the first external information, the condition regarding division granularity, or the condition regarding a portion of an object, and an optimal mask map may be automatically selected from among the plurality of mask maps for each scene in a video of projection mapping.

### 3. Modifications

The embodiments described above can be modified as follows.

(1) In the embodiments described above, the area information is generated based on the captured image of the entire projection area and the first external information on the feature of distance (the distance from the external sensor 30) or color in the projection area. However, it is also possible to further acquire second external information representing a feature regarding an environment of the projection area or an appearance or movement of the projection object, and acquire the area information based on the captured image, the first external information, and the second external information. Specific examples of the second external information on the appearance of the projection object include information representing texture of the projection object, reflection characteristics (reflectance, scattering characteristics, or the like), information on distribution of normal vectors, information on edges representing a contour of the projection object, information representing a pattern (including characters) formed on a surface of the projection object, and information representing feature points on the surface of the projection object.

(2) The first acquisition unit 111, the second acquisition unit 112, the third acquisition unit 113, and the determination unit 114 in the embodiment described above are software modules. However, any one, any two, any three, or all of the first acquisition unit 111, the second acquisition unit 112, the third acquisition unit 113, and the determination unit 114 may be a hardware module such as an application specific integrated circuit (ASIC). Even if at least one of the first acquisition unit 111, the second acquisition unit 112, the third acquisition unit 113, and the determination unit 114 is a hardware module, the same effects as the effects of the embodiments described above are achieved.

(3) The program PRA may be manufactured alone and may be provided for payment or free of charge. Specific forms of providing the program PRA include a form of writing and providing the program PRA in a computer-readable recording medium such as a flash ROM and a form of downloading and providing the program PRA through an electrical communication line such as the Internet. By operating a general computer according to the program PRA provided in these forms, the computer can execute the determination method of the present disclosure.

### 4. Summary of Present Disclosure

The present disclosure is not limited to the above-described embodiments and modifications and can be implemented in various aspects without departing from the range of the spirit and scope of the present disclosure. For example, the present disclosure can also be implemented in the following aspects. Technical features in the above-described embodiments corresponding to technical features in the aspects described below can be replaced or combined as appropriate in order to solve a part or all of the problems of the present disclosure or in order to achieve a part or all of the effects of the present disclosure. Further, the technical features can be deleted as appropriate unless described as essential features in the present specification.

The present disclosure will be summarized below in the form of appendixes.

### Appendix 1

A determination method of an area for displaying content according to the present disclosure includes: acquiring a captured image including a projection area in which a projection object serving as a display destination of content including a plurality of images is disposed; acquiring area information for dividing the captured image into a plurality of areas and grouping the plurality of areas, based on the captured image and first external information on a feature of distance or color in the projection area; and determining, for each of the plurality of areas, an image to be displayed in the area among the plurality of images for each group based on the area information. According to the determination method of this aspect, by grouping the projection areas, the images constituting the content can be set to the grouped areas.

### Appendix 2

A more preferred aspect of the determination method according to appendix 1, in which
the acquiring the area information includes identifying the projection object based on the captured image, and
the area information is information indicating division of an image of the identified projection object into a plurality of areas. According to this aspect, by setting a plurality of areas for one projection object and grouping areas having similar features of distance or color, it is possible to set the images constituting the content to the grouped areas.

### Appendix 3

A further more preferred aspect of the determination method according to appendix 2, in which
the identifying the projection object includes identifying a type of the projection object based on the captured image, and
the area information is information indicating division of an image of the identified projection object into a plurality of areas based on the identified type of the projection object. According to this aspect, it is possible to group the plurality of areas set for the projection object according to the type of the projection object and set the images constituting the content to the grouped areas.

### Appendix 4

Another preferred aspect of the determination method according to appendix 1, in which
the acquiring the area information includes identifying a plurality of the projection objects based on the captured image when the plurality of the projection objects are reflected in the captured image and grouping the plurality of the projection objects based on the captured image and the first external information. According to this aspect, when a plurality of projection objects are disposed in the projection area, it is possible to group the projection objects having similar features indicated by the first external information and set the images constituting the content to the grouped projection objects.

### Appendix 5

A further more preferred aspect of the determination method according to appendix 4, in which
the identifying the plurality of the projection objects based on the captured image includes identifying a type of each of the plurality of the projection objects based on the captured image, and
the grouping the plurality of the projection objects includes grouping the plurality of the projection objects based on the type of each of the plurality of projection objects. According to this aspect, it is possible to group the plurality of projection objects disposed in the projection area according to the type of the projection object and set the images constituting the content to the grouped projection objects.

### Appendix 6

Another preferred aspect of the determination method according to any one of appendix 1 to appendix 5, further including:
acquiring second external information representing a feature regarding an environment of the projection area or an appearance or movement of the projection object, in which
the acquiring the area information includes acquiring the area information based on the captured image, the first external information, and the second external information. According to this aspect, it is possible to group the areas having common characteristics regarding the environment, the appearance, or the movement, and set the images constituting the content to the grouped areas.

What is claimed is:

1. A determination method of an area for displaying content, the determination method comprising:
acquiring a captured image including a projection area in which a projection object serving as a display destination of content including a plurality of images is disposed;
acquiring area information for dividing the captured image into a plurality of areas and grouping the plurality of areas, based on the captured image and first external information on a feature of distance or color in the projection area; and
determining, for each of the plurality of areas, an image to be displayed in the area among the plurality of images for each group based on the area information.

2. The determination method of an area for displaying content according to claim 1, wherein
the acquiring the area information includes identifying the projection object based on the captured image, and
the area information is information indicating division of an image of the identified projection object into a plurality of areas.

3. The determination method of an area for displaying content according to claim 2, wherein
the identifying the projection object includes identifying a type of the projection object based on the captured image, and
the area information is information indicating division of an image of the identified projection object into a plurality of areas based on the identified type of the projection object.

4. The determination method of an area for displaying content according to claim 1, wherein
the acquiring the area information includes identifying a plurality of the projection objects based on the captured image when the plurality of the projection objects are reflected in the captured image and grouping the plurality of the projection objects based on the captured image and the first external information.

5. The determination method of an area for displaying content according to claim 4, wherein
the identifying the plurality of the projection objects based on the captured image includes identifying a type of each of the plurality of the projection objects based on the captured image, and
the grouping the plurality of the projection objects includes grouping the plurality of the projection objects based on the type of each of the plurality of the projection objects.

6. The determination method of an area for displaying content according to claim 1, further comprising:
acquiring second external information representing a feature regarding an environment of the projection area or an appearance or movement of the projection object, wherein
the acquiring the area information includes acquiring the area information based on the captured image, the first external information, and the second external information.
